(19) United States
(12) Patent Application Publication
(10) Pub. No.: US 2018/0063098 A1
(43) Pub. Date: Mar. 1, 2018

(54) Vehicle Network Interface Tool

(71) Applicants: David Robins, Birmingham, MI (US); Jonathan Schwartz, West Bloomfield, MI (US); Jeffery Quesnelle, Royal Oak, MI (US)

(72) Inventors: David Robins, Birmingham, MI (US); Jonathan Schwartz, West Bloomfield, MI (US); Jeffery Quesnelle, Royal Oak, MI (US)

(21) Appl. No.: 15/249,670

(22) Filed: Aug. 29, 2016

(51) Int. Cl. H04L 29/06; G06F 21/60

(52) U.S. Cl. CPC H04L 63/0471; G06F 21/602; H04L 67/12; H04L 2209/84; H04L 63/0853

(57) ABSTRACT

A vehicle network interface tool electrically connects a computing device to an electronic control unit of a motor vehicle. The vehicle network interface tool includes a vehicle communications port to receive vehicle network data from the electronic control unit of the motor vehicle. A crypto-processor decrypts the vehicle network data and creates computing device readable data. A main processor receives the computing device readable data and transmits it to a computing device port. A computing device port is in electrical communication with the main processor. The computing device receives the computing device readable data from said main processor and transmits the computing device readable data to the computing device for analysis. Being able to receive and decrypt encrypted data keeps the integrity of the ECU security preventing hacks to the ECU.

### BACKGROUND ART

### 1. Field of the Invention

The invention relates to vehicle network interface tools used to bidirectionally communicate with electronic control units of a vehicle. More particularly, the invention relates to a vehicle network interface tool that allows for bidirectional communication between electronic control units for a vehicle and an external computing device wherein the communications to and from the electronic control units are encrypted and/or authenticated.

### 2. Description of the Related Art

Modern electronic control units (ECUs) include engine electronic control units and transmission electronic control units, and will hereinafter be referred to as ECUs. ECUs are highly complex systems that implement a plurality of real-time control algorithms within a single microcontroller. To aid in the development and testing of these real-time control algorithms, it is sometimes necessary to connect a vehicle network interface tool to a personal computer and the vehicle's built in vehicle network, which provides real-time access to information exchanged on the vehicle networks. Developers are able to perform high speed data acquisition (DAQ) to observe the data on the in-vehicle network, high speed data stimulation (STIM) to inject new or replace data on the in-vehicle network to simulate new ECU's or modify existing ECU behavior on the network.

As a vehicle becomes more dependent on the commands of the ECUs, there are more opportunities to hack into the ECUs and alter, change or delete commands, which may compromise the ability of the ECUs to function properly. Even during testing, it is becoming increasingly important to secure the communications between the vehicle network interface tool and the ECUs in the vehicle as well as the communication between various ECUs in the vehicle.

### SUMMARY OF THE INVENTION

A vehicle network interface tool electrically connects a computing device to an electronic control unit of a motor vehicle. The vehicle network interface tool includes a vehicle communications port to receive vehicle network data from the electronic control unit of the motor vehicle. A crypto-processor decrypts the vehicle network data and creates computing device readable data. A main processor receives the computing device readable data and transmits it to a computing device port. A computing device port is in electrical communication with the main processor. The computing device receives the computing device readable data from said main processor and transmits the computing device readable data to the computing device for analysis.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a motor vehicle with a computing device operatively connected to the electronic control units using one embodiment of the invention;

FIG. 2 is a schematic representation of FIG. 1;

FIG. 3 is a block diagram showing data flow between the various elements during the step of authentication;

FIG. 4 is a block diagram showing data flow between the various elements during the step of transmitting encrypted data; and

FIG. 5 is a top view of a printed circuit board incorporating one embodiment of the invention.

### DETAILED DESCRIPTION OF THE PREFERRED EMBODIMENT

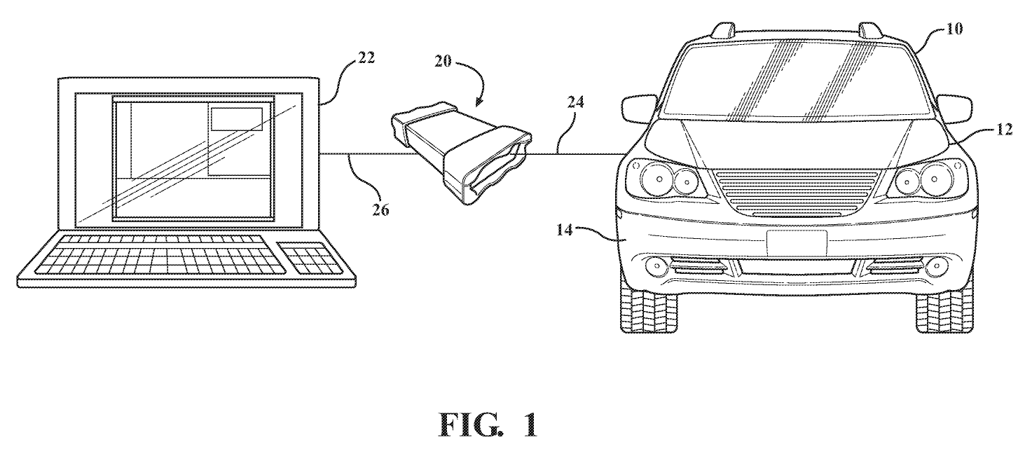

Referring to FIG. 1, a vehicle 10 includes an engine compartment under a hood 12. The hood 12 covers the engine compartment, which houses an engine (not shown). It should be appreciated by those skilled in the art that the engine may be an internal combustion engine or any other type of device that is able to control some aspect of the vehicle 10 and/or propel the vehicle 10. Also, while the engine compartment is discussed above as being under the hood 12 adjacent a front end 14 of the vehicle 10, it should be appreciated that the engine compartment may exist toward the middle or in the rear of the vehicle 12.

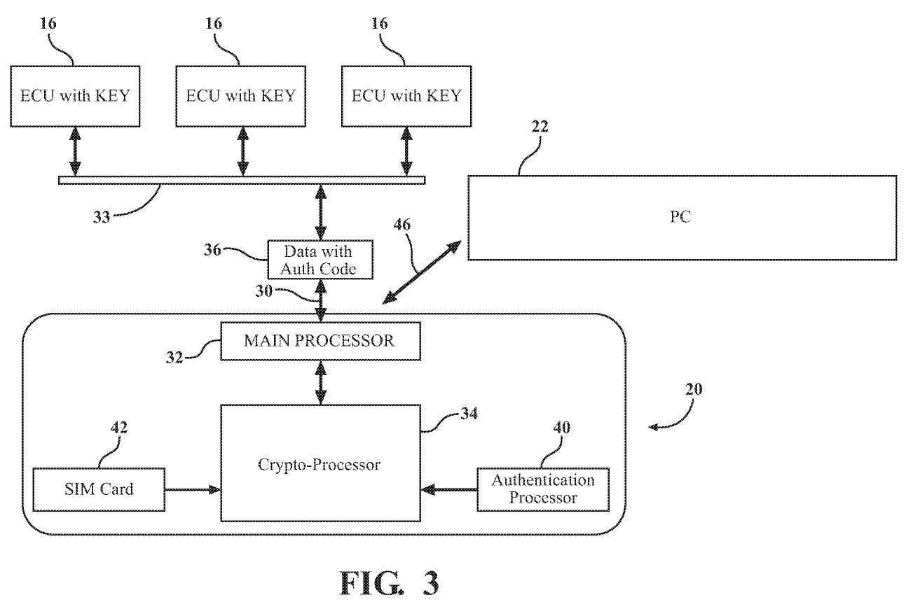

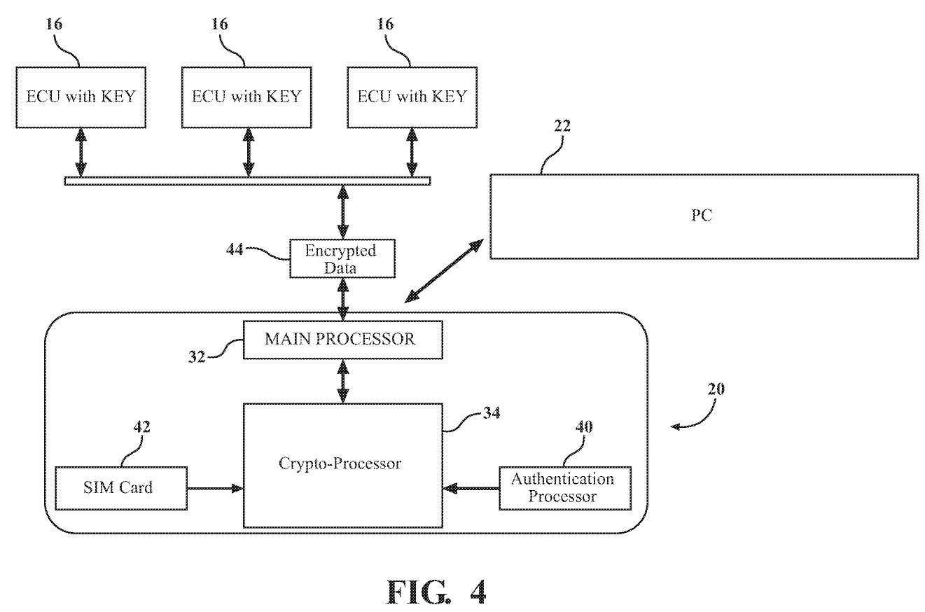

The engine drives a transmission (also not shown). Both the engine and the transmission are electronically controlled. Electronic control units (ECUs) 16 are diagrammatically shown in FIGS. 3 and 4. The ECUs 16 control the operation of the engine, transmission and other functional vehicle devices. The invention relates to the ECUs 16 communication with each other and it may be used in conjunction with any ECU, whether it is the engine ECU 16, the transmission ECU, a motor ECU, a battery ECU, or any other ECU.

A vehicle network interface tool, generally indicated at 20, enables a computing device 22 to communicate on networks of the vehicle 10. Cables 24, 26 are any standard transmission cables that are designed to bidirectionally transmit data between two or more electronic devices. The vehicle network interface tool 20 allows data to be collected from and transmitted to the ECUs 16 via the cable or data line 24 and transmitted across the cable or data line 26 to be analyzed by a computing device 22. In FIG. 1, the computing device is a laptop computer 22. It should be appreciated by those skilled in the art that the computing device 22 may be any device capable of receiving, transmitting, analyzing and/or displaying data.

Referring to FIG. 3, the vehicle network interface tool 20 includes a vehicle communications port 30, which is schematically shown. And while it should be appreciated by those skilled in the art that the vehicle network interface tool 20 may include a plurality of vehicle communications ports 30, the remainder of the discussion will only discuss a singular vehicle communications port 30 to simplify the discussion. The vehicle communications port 30 receives authentication codes (discussed in greater detail subsequently) and the vehicle network data from the ECUs 16 of the motor vehicle 10. The vehicle network data either can be encrypted or not depending on the specific application. A main processor 32 receives the vehicle network data from the ECUs 16 and processes the vehicle network data into computing device readable data. Additionally, this process also works in reverse.

For situations where it is desired to simulate data and have that loaded into the electronic control units 16, the computing device 22 generates data and transmits the generated data to the vehicle network interface tool 20 which, in turn creates an authentication code for the generated data and optionally encrypts the generated data using stored keys (discussed in greater detail subsequently). After an authentication code is generated for the generated data, the authentication code is transmitted along with the generated data, or optionally the encrypted generated data, to the ECUs 16 in the vehicle.

In one embodiment of the invention, the vehicle network data is encrypted by the ECUs 16 in the vehicle before it is transmitted on the vehicle networks 33. Before the main processor 32 is able the convert the encrypted vehicle network data into computing device readable data, a crypto-processor 34 decrypts the vehicle network data. To begin the process, the vehicle network interface tool 20 receives encrypted data from one or more of the ECUs 16 equipped with a key, as is schematically shown in FIG. 3. The matching key to calculate the appropriate encryption algorithm is stored in either an authentication processor 40 or a subscriber identity module (SIM) card 42. Depending on the systems used by the manufacturer of the particular ECU 16 and/or the motor vehicle 10, either the authentication processor 40 or the SIM card 42 is used. The vehicle network interface tool 20 is designed with both options so that it can be universally used by all types of ECUs 16 and all types of motor vehicles 10. As discussed above, this process also works in reverse, where the computing device 22 creates data and sends the data to the vehicle network tool 20. The key stored in the vehicle network tool is used to encrypt the data and send them to the ECUs 16 in the vehicle 10. The ECUs 16 then use their stored key to decrypt the data.

Referring to FIG. 3, the vehicle network data is sent by the ECUs 16 with a corresponding authentication code that is calculated from the data and keys stored in the ECUs 16. In order to ensure the data is transmitted from a valid source, the main processor 32 of the vehicle network tool 20 sends the vehicle network data to a crypto-processor 34. Using this data and the key stored in either a SIM card 42 or authentication processor 40, the crypto-processor 34 also calculates an authentication code. If the authentication code calculated by the crypto-processor 34 matches that of the authentication code sent by the ECUs 16, then the vehicle network interface tool 20 ensures that the data came from a valid ECU source. This process also work in reverse. If desired, the computing device 22 sends valid data to one or more of the ECUs 16 by first transmitting the data to the vehicle network interface tool 20. The vehicle network interface tool 20 then converts the data to a format readable by the ECUs 16, and using a key stored in either the SIM card 42 or authentication processor 40 and the data, the vehicle network interface tool 20 calculates an authentication code that is transmitted to the ECUs 16 along with the data. The ECUs 16 in turn calculate their own authentication code using internally stored keys and the data. If the authentication code sent by the vehicle network tool matches that of the authentication code calculated by the ECUs, the ECUs then know the vehicle network data are from a valid and good source.

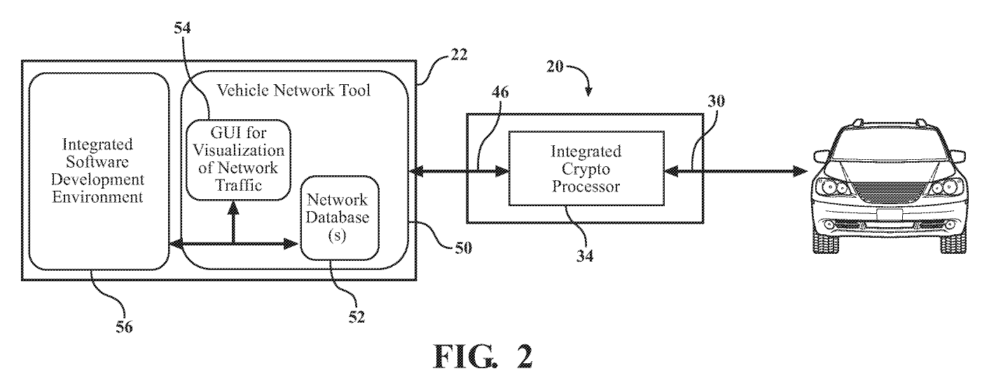

Referring to FIG. 2, the computing device 22 is shown to include a vehicle network tool 50. The vehicle network tool 50 includes one or more network databases 52 and a graphic user interface (GUI) 54 for assisting a user in visualizing the network traffic. Because the vehicle network interface tool 20 and the vehicle network tool 54 are designed to allow a user to read data and transmit data bidirectionally to and from the ECUs 16 to affect any change in the data desired by the user, all of the lines of communication are shown as bidirectional lines allowing data to travel in either direction.

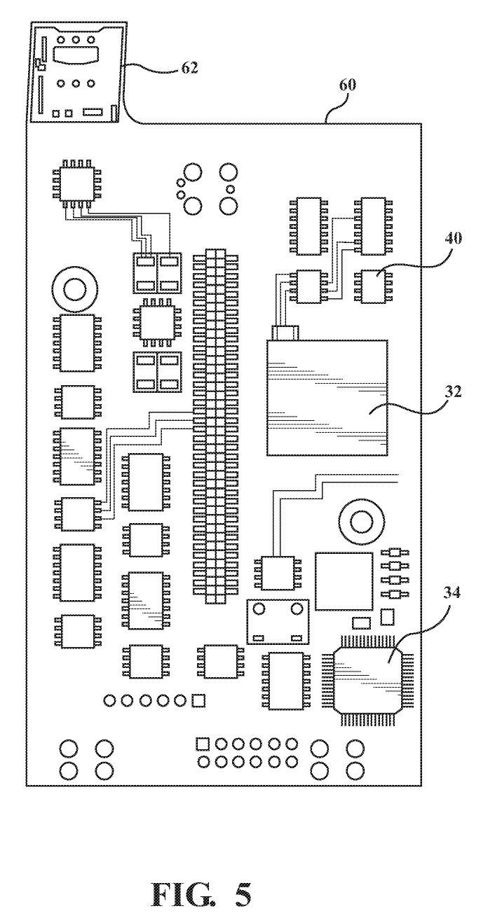

Referring to FIG. 5, a printed circuit board 60 is designed to be housed within the vehicle network interface tool 20. A reading device 62 is disposed at the top of the printed circuit board 60 (based on the orientation of the printed circuit board 60 as shown in FIG. 5). In the embodiment shown, the reading device 62 is a SIM card reader 62. The main processor 32, crypto-processor 34 and authentication processor 40 are also shown.

In the description herein, a crypto-processor is used to encrypt, decrypt data and calculate the authentication codes. It should be noted that, the main processor and a variety of other chips also have this ability, albeit at a slower rate than the crypto-processor. In the embodiment described herein, a crypto-processor is used because of the real-time and high speed and volume of data required to be processed in vehicle communications.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A vehicle network interface tool for operatively connecting a computing device to an electronic control unit of a vehicle, said vehicle network interface tool comprising:
a vehicle communications port to bidirectionally transfer vehicle network data to and from the electronic control unit of the vehicle;
a crypto-processor connected to said vehicle communications port for decrypting the vehicle network data to create computing device readable data when receiving vehicle network data from the electronic control unit, and for encrypting computing device readable data into encrypted vehicle network data when transmitting to the electronic control unit;
a main processor for bidirectionally transmitting and receiving the computing device readable data to and from said crypto-processor; and
a computing device port in communication with said main processor for bidirectionally transmitting and receiving the computing device readable data between said main processor and the computing device such that the computing device readable data transmitted to the computing device may be analyzed and the computing device readable data created by the computing device may be transmitted to said main processor for transmission to said electronic control unit.

2. A vehicle network interface tool as set forth in claim 1 including a reading device for receiving and reading a removable subscriber identity module card for encryption, decryption and authentication of communications transmitted and received through said vehicle communications port.

3. A vehicle network interface tool as set forth in claim 2 including an authentication processor for authenticating communications transmitted and received through said vehicle communications port.

4. A vehicle network interface tool for operatively connecting a computing device to an electronic control unit of a vehicle, said vehicle network interface tool comprising:
a vehicle communications port to bidirectionally transfer vehicle network data to and from the electronic control unit of the vehicle;
a crypto-processor connected to said vehicle communications port for decrypting the vehicle network data to create computing device readable data when receiving vehicle network data from the electronic control unit, and for encrypting computing device readable data into encrypted vehicle network data when transmitting to the electronic control unit;
a main processor for bidirectionally transmitting and receiving the computing device readable data to and from said crypto-processor; and
a computing device port in communication with said main processor for bidirectionally transmitting and receiving the computing device readable data between said main processor and the computing device such that the computing device readable data transmitted to the computing device may be analyzed and the computing device readable data created by the computing device may be transmitted to said main processor for transmission to said electronic control unit; and
an authentication processor for authenticating communications received through said vehicle communications port.
